(19) United States
(12) Patent Application Publication
(10) Pub. No.: US 2007/0027915 A1
(43) Pub. Date: Feb. 1, 2007

(54) Method and system for processing a workflow using a publish-subscribe protocol

(76) Inventor: Robert P. Morris, Raleigh, NC (US)

Correspondence Address: SCENERA RESEARCH, LLC, 111 Corning Road, Suite 220, Cary, NC, 27518, US

(21) Appl. No.: 11/192,489

(22) Filed: Jul. 29, 2005

(51) Int. Cl. G06F 17/00

(52) U.S. Cl. 707/104.1

(57) ABSTRACT

A method for processing a workflow includes using a publish-subscribe protocol to receive from a server information related to a task in a workflow process, which comprises a plurality of tasks to produce a final outcome. A next task is determined based on the information and information related to the next task is sent to at least one task device capable of processing the next task via the server using the publish-subscribe protocol.

### RELATED APPLICATIONS

The present application is related to co-pending U.S. patent application Ser. No. 11/______ entitled “METHOD, SYSTEM, AND DATA STRUCTURE FOR PROVIDING A GENERAL REQUEST/RESPONSE MESSAGING PROTOCOL USING A PRESENCE PROTOCOL,” filed on, ______, 2005, and assigned to the assignee of the present application. The present application is also related to co-pending U.S. patent application Ser. No. 11/118,882 entitled “SYSTEM AND METHOD FOR UTILIZING A PRESENCE SERVICE TO ADVERTISE ACTIVITY AVAILABILITY,” filed on Apr. 29, 2005, and assigned to the assignee of the present application. The present application is also related to co-pending U.S. patent application Ser. No. 11/096,764, entitled “SYSTEM AND METHOD FOR UTILIZING A PRESENCE SERVICE TO FACILITATE ACCESS TO A SERVICE OR APPLICATION OVER A NETWORK,” filed on Mar. 31, 2005, and assigned to the assignee of the present application. The present application is also related to co-pending U.S. patent application Ser. No. 10/960,365, entitled “SYSTEM AND METHOD FOR UTILIZING CONTACT INFORMATION, PRESENCE INFORMATION AND DEVICE ACTIVITY,” and co-pending U.S. patent application Ser. No. 10/960,135, entitled “SYSTEM AND METHOD FOR UTILIZING CONTACT INFORMATION, PRESENCE INFORMATION AND DEVICE ACTIVITY,” both filed on Oct. 6, 2004, and both assigned to the assignee of the present application. The present application is also related to co-pending U.S. patent application Ser. No. 10/900,558, entitled “SYSTEM AND METHOD FOR PROVIDING AND UTILIZING PRESENCE INFORMATION,” filed on Jul. 28, 2004, and assigned to the assignee of the present application. The present application is also related to co-pending U.S. patent application Ser. No. 10/903,576, entitled “SYSTEM AND METHOD FOR HARMONIZING CHANGES IN USER ACTIVITIES, DEVICE CAPABILITES AND PRESENCE INFORMATION,” filed on Jul. 30, 2004, and assigned to the assignee of the present application. Each of the above-cited related applications is incorporated here by reference in its entirety.

### BACKGROUND

Workflow is defined as a series of tasks or activities to produce a final outcome. Typically, workflow is concerned with the automation of procedures where documents and/or information are passed between participants according to a defined set of rules to achieve the overall business goal. Although a workflow can be manually directed, e.g., by a supervisor, such a process is tedious, time consuming, and labor intense. Moreover, if the supervisor is not available or absent, the workflow can be interrupted or stalled until the supervisor returns or is available. In today's business environment, such delays result in loss revenues and lowered productivity.

To remove the burden of workflow management from a worker, computerized workflow management systems have been developed. A typical workflow management system includes a software application package that provides procedural automation of a business process by managing the sequence of tasks and invoking appropriate human and/or IT resources associated with the various tasks. In general, a workflow management system supports building/defining a workflow, managing run-time process control functions and managing run-time activity interactions.

Defining the workflow involves identifying a number of discrete activity steps or tasks and associating them with computer and/or human operations. The progression of the process through the various tasks is governed by defined rules and/or policies. At run-time, the workflow is interpreted by the workflow management system which creates and controls operational instances of the process, schedules the various tasks within the process, and invokes the appropriate human and IT application resources. The workflow management system is capable of transferring control between tasks, checking on the status of tasks, and invoking application tools and passing the appropriate information to the application or human resource.

Each task in the workflow can be hard-linked to the next task in the sequence, which places the decision making outcome in a service provider that executes a task of the workflow. Alternatively, the workflow can be centrally managed by a central server that tracks all aspects of the workflow and manages load balancing among service providers. In this arrangement, each service provider typically uses a communication protocol supported by the server to exchange information with the server. Alternatively, a combination of the two can be implemented.

As one can imagine, the development of workflow management system products has evolved at a rapid pace. Various workflow management system tools have been introduced to support document flow, electronic messaging, IT application development, and a host of other functions. Such systems can be implemented in a variety of ways, some of which are standard and some of which are proprietary. The workflow management systems can use a wide variety of IT and communication infrastructures and operate in an environment ranging from small local workgroup to inter-enterprise. Due to this diversity, most workflow management system tools generally are not interoperable. That is, most workflow management systems cannot interact with other workflow management systems because they do not utilize the same framework and/or protocols. So, if a workflow is defined using one workflow management system tool, that workflow generally cannot be used by another workflow management system tool without substantial modifications. Moreover, service providers that can perform one or more tasks for one workflow management system tool cannot offer their services to other workflow management system tools unless the service providers are familiar with the other workflow management system tool's protocol and APIs.

Accordingly, it is desirable to have a more flexible framework for implementing a workflow management system. The framework should be based on an existing protocol that readily supports run-time process control functions and run-time activity interactions. The framework should allow several service providers to be available to perform a task without requiring any of the service providers to be familiar with the workflow management system. The framework should also support centralized and decentralized management of the workflow.

### SUMMARY

Methods, a system and a computer readable medium containing program instructions are disclosed for processing a workflow. In one embodiment, a method includes using a publish-subscribe protocol to receive from a server information related to a task in a workflow process, which comprises a plurality of tasks to produce a final outcome. A next task is determined based on the information and information related to the next task is sent to at least one task device capable of processing the next task via the server using the publish-subscribe protocol.

In another embodiment, a method for processing a workflow includes using a publish-subscribe protocol to receive from a server information related to a task in a workflow process that includes a plurality of tasks and determining whether to perform the task based on the information. If the task is performed, a result is produced. The method includes using the publish-subscribe protocol to publish the result via the server.

In another embodiment, a system for processing a workflow that comprises a plurality of tasks for producing a final outcome includes a server configured to receive, store, and distribute information using a publish-subscribe protocol and a plurality of task devices. At least one task device is configured to perform a task in the workflow and is configured to exchange information with the server u sing the publish-subscribe protocol.

### DESCRIPTION OF THE DRAWINGS

The accompanying drawings provide visual representations which will be used to more fully describe the representative embodiments disclosed here and can be used by those skilled in the art to better understand them and their inherent advantages. In these drawings, like reference numerals identify corresponding elements, and:

FIG. 1 illustrates a system for processing a workflow using a publish-subscribe protocol according to an embodiment of the present invention.

FIG. 2 is a block diagram illustrating the various components that can form a task device according to an embodiment of the present invention.

FIG. 3 is a block diagram illustrating the workflow server according to an embodiment of the present invention.

FIG. 4 illustrates a data structure for use with a presence protocol according to one embodiment of the present invention.

FIG. 5 shows an expanded view of the request data object according to an embodiment of the present invention.

FIG. 6 shows an expanded view of the response data object according to an exemplary embodiment.

FIG. 7 is a flowchart illustrating a method for processing a workflow according to one embodiment of the present invention.

FIG. 8 is a sequence diagram illustrating a method for processing the workflow using a centralized workflow manager according to an embodiment of the present invention.

FIG. 9 is a sequence diagram illustrating a method for processing the workflow using a distributed network of task devices according to an embodiment of the present invention.

FIG. 10 illustrates another method of processing a workflow using a distributed network of task devices according to another embodiment of the present invention.

### DETAILED DESCRIPTION

Various aspects will now be described in connection with exemplary embodiments, including certain aspects described in terms of sequences of actions that can be performed by elements of a computer system. For example, it will be recognized that in each of the embodiments, the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described.

According to one embodiment of the present invention, a workflow management system utilizes a publish-subscribe (pubsub) protocol to process the workflow. The pubsub communication model is a well-known communication protocol in which a person or application publishes information, and an event notification or the data itself is broadcasted to all authorized subscribers. In general, the relationship between the publisher and subscriber is mediated by a pubsub service that receives publication requests, broadcasts event notifications and/or the data itself to subscribers, and enables privileged entities to manage lists of people or applications that are authorized to publish or subscribe. The pubsub service preferably receives publication requests that include a request to perform a task in the workflow, and broadcasts the request to one or more task devices that are capable of performing the task. The task devices can be subscribers to the pubsub service and can also publish their responses to the pubsub service. It will be understood that other task devices can perform tasks in the workflow and can otherwise contribute to the workflow process outside of the pubsub environment.

In one embodiment, the workflow can be centrally managed by a workflow manager that maintains, monitors, and allocates task requests. The workflow manager is authorized to publish and subscribe to information via the pubsub service. In another embodiment, the workflow is processed between task devices without the workflow manager, resulting in a distributed (or peer-to-peer) workflow process. In this embodiment, information about the workflow is available either in the request itself or elsewhere such that a decision regarding what the next task is can be made on the fly. While the descriptions of each of these embodiments use the terms “request” and “response” to describe the messages that are exchanged between devices in the performance of workflow tasks, the “request” and “response” messages should not be considered as linked in the strict request/response protocol manner. That is, a requesting device need not wait for a response from a responding device to carry on with other tasks or functions in the workflow process (or, perhaps, another workflow process). Similarly, a responding device need not directly respond to the requesting device after carrying out a particular requested task. This distinction is particularly true in the context of the second embodiment related to distributed workflow processing. Each embodiment will be discussed in more detail below.

In a preferred embodiment of the present invention, the pubsub protocol can be a presence protocol and the pubsub service can be a presence service. In general, the presence service provides similar functionalities of the pubsub service in addition to conveying a user's presence on a network to other network users based on the user's connectivity to the network via a computing and/or communication device. Information describing users' presence on a network can be use by the workflow management system of the present invention.

The architecture, models, and protocols associated with presence services in general are described in “Request for Comments” (or RFC) documents RFC 2778 to Day et al., titled “A Model for Presence and Instant Messaging” (February 2000), and RFC 2779 to Day et al., titled “Instant Messaging/Presence Protocol” (February 2000), each published and owned by the Internet Society. The presence service model described in RFC 2778 describes two distinct users of a presence service, referred to as presence “clients”. The first of these clients, called a presentity (combining the terms “presence” and “entity”), provides presence information to be stored and distributed throughout the presence service. Presence information includes the status of a user of the presence service and may include additional information used by the presence service. This additional information can include, for example, the preferred communication means, e.g., telephone or email, and corresponding contract address, e.g., telephone number or email address) of the user.

Presence information can be stored or maintained in any form for use by the presence service, but typically is organized into portions referred to as presence tuples. As will be understood by those skilled in the art, a tuple, in its broadest sense, is a data object containing one or more components. A presence tuple can include an identifier of a user and the user's status, contact address, or other information used by the presence service.

The second type of presence client is referred to as a “watcher”. Watchers receive presence information from the presence service. The presence model of RFC 2778 describes types of watchers, referred to as “subscribers” and “fetchers.” A subscriber requests notification from the presence service of a change in some presentity's presence information. The presence service establishes a subscription on behalf of the subscriber to a presentity's presence information, such that future changes in the presentity's presence information are “pushed” to the subscriber. In contrast, the fetcher class of watchers requests (or fetches) the current value of some presentity's presence information from the presence service. As such, the presence information can be said to be “pulled” from the presence service to the presentity. A special kind of fetcher, referred to as a “poller,” is defined in the model as one that fetches information on a regular (or polling) basis.

The presence service can also manage, store, and distribute presence information associated with watchers, as well as the watchers' activities in terms of the fetching or subscribing to the presence information of other presence clients using the presence service. This “watcher information” can be distributed to other watchers by the presence service using the same mechanisms that are available for distributing the presence information of presentities. It will be understood that while the model describes the presentity and watcher as separate entities, these entities can be combined functionally as a single presence entity having the characteristics of both a presentity and a watcher. Accordingly, the phrase “presence entity” (in contrast to the term “presentity”) or more simply the term “entity” with an appropriate modifier (e.g., responding, requesting, receiving, or sending) will be used throughout this document to describe any one or any combination of all of the presentity, watcher, subscriber, fetcher, or poller entities described above.

Users of the presence service are referred to in the presence model described in RFC 2778 as principals. Typically, a principal is a person or group that exists outside of the presence model, but can also represent software or other resources capable of interacting with the presence service. The model does not define the requirements or functionality of principals, but does state that two distinct principals be distinct, and two identical principals be identical. For purposes of this document, this strict interpretation of principals should not be adopted—that is, two distinct principals need not be distinct, and two identical principals need not be identical. For example, the 3rd Generation Partnership Project (3GPP) has included standards for incorporating presence services into their Universal Mobile Telecommunications System (UMTS) that define the use of “public identities” for users of the UMTS. A particular UMTS user may have several public identities. Consequently, were such a public identity to be construed as a principal, the public identity as a principal could be associated with more than one presence client.

According to the general presence model described in RFC 2778, a principal can interact with the presence system through a presence user agent (PUA) or a watcher user agent (WUA). As in the case of the presentity and watcher clients to which these user agents interact, the presence and watcher user agents can be combined functionally as a single user agent having both the characteristics of the presence and watcher user agents. User agents can be implemented such that their functionality exists within the presence service, external to the presence service, or a combination of both internal and external to the presence service.

While the various presence service and presence protocol embodiments used today have differences, all of these embodiments use presence architectures and protocols that are consistent with the presence model and protocols described in RFC 2778 and RFC 2779 in terms of features and function. Accordingly, the terms used here should not be limited to any one of the presence models, services, and/or protocol embodiments in use today.

For example, today's presence protocols each support a common set of messages (or commands) from a functional standpoint (see, e.g., RFC 2779). These functional commands include:
Publish: Allowing a presence entity (through a PUA/presentity) to update/provide its own presence information (e.g. its status or contact information) to a presence server;
Notify: Allowing a presence server to provide information from a presence tuple to a WUA/watcher. Notifications may be point-to-point (e.g., via a directed publish/notify command as described in the following paragraph) or broadcast; and
Subscribe (Unsubscribe): Allowing a WUA/watcher to subscribe or unsubscribe to notifications related to specific presence information.
   The phrase “presence protocol”, as used here, includes at least those commands to allow entities to publish presence information, notify entities of other entities' presence information, and allow entities to subscribe (unsubscribe) to other entities' presence information.

Several optional, functionally equivalent presence commands also exist. These optional commands include:
Probe: Allowing a presence service to get information associated with a presence entity. This is equivalent to a combined Notify/Publish command except that the presence service requests presence information rather than having the presence client send the information unsolicited; and
Directed Publish/Notify: Allowing a client to issue a publish command that results in a notify command being sent to a specific presence client, thus bypassing the subscription function.

There is also a functional equivalent set of commands for managing a “friends list” (or “roster”) related to presence services. This set of commands includes:
Request: Allowing a client to request a specific or default roster;
Add: Allowing a client to add an item for a presence entity to a roster;
Update: Allowing a client to update a roster item; and
Delete: Allowing a client to delete an item from a roster.
   Related to rosters are privacy lists. A privacy list can be generally described in terms of a roster configured to identify presence clients that are to be blocked from interacting with the owner of the roster/privacy list.

As discussed above, a presence service is a type of pubsub service, thus the requirements for a pubsub service can be less strict. A pubsub service, at minimum, should support Publish, Subscribe, and Notify commands, or their equivalents. The data carried by the pubsub protocol and handled by the pubsub service can be referred to as a tuple. A tuple in a pubsub service is a data object containing one or more components. A pubsub server may store tuples and send notifications containing the tuple data to subscribers, or it may simply send notifications to subscribers without storing the tuple data.

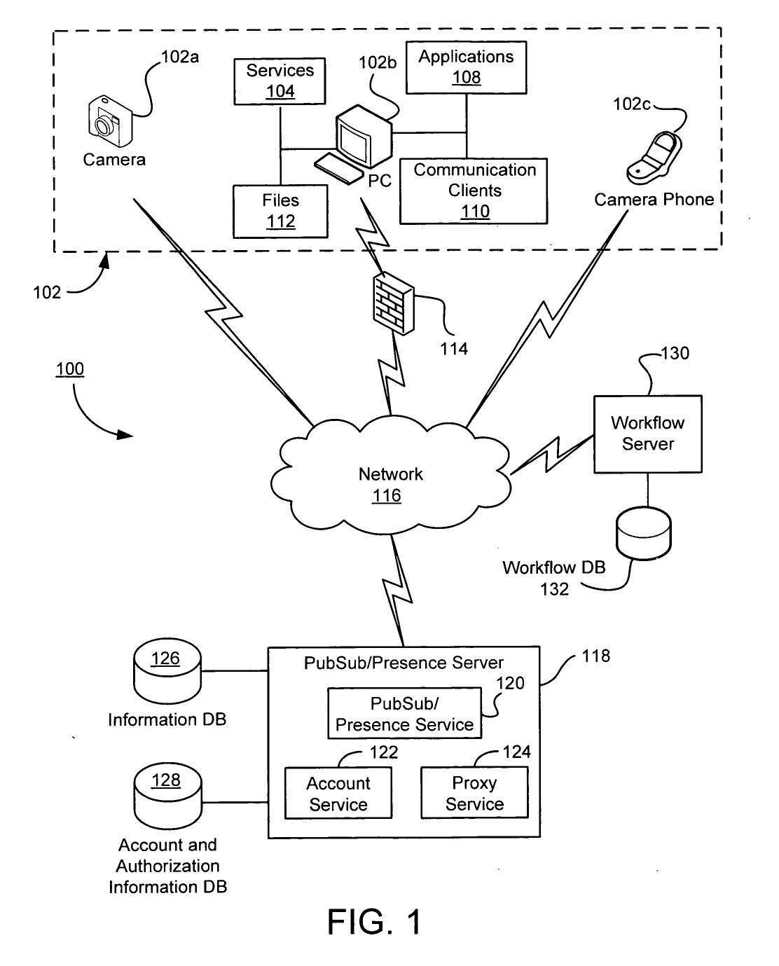

Referring now to FIG. 1, a system 100 is depicted for processing a workflow using a pubsub protocol. The system includes a pubsub server 118 configured to receive, store, and distribute information via a pubsub service 120. The system further includes a plurality of task devices 102 and, optionally, a workflow server 130. Both are configured to exchange information with the pubsub server 118 via the network 116 using a pubsub protocol. The task devices 102 can include any of Personal Computers (PCs), servers, Personal Digital Assistants (PDAs), network-enabled cameras, camera phones, cell phones, and the like.

Although depicted as a stand-alone server in FIG. 1, the pubsub server 118 can include several servers (not shown) that together can function as the pubsub service 120. Moreover, the function of the pubsub server 118 can be incorporated, either in whole or in part, into any of the devices 120 and server 118 shown in the figure, and thus can be distributed throughout the network of elements shown. As such, the meaning of “pubsub server” or “presence server” used here does not strictly conform to the definition of a “server” included in RFC 2778 as being an indivisible unit of a presence service. Nevertheless, the pubsub server 118 and pubsub service 120 are closely linked to one another and can be considered to perform one and the same function. As used here, however, the pubsub server 118 can also include additional services, such as the account service 122 and proxy service 124 shown in FIG. 1, although these additional services need not be included in the server 118. It will be understood that these additional services can also be distributed across one or more servers or devices 102 interconnected via the network 116.

A task device can be, for example, a PC, such as the PC 102b shown in FIG. 1. The task device 102b includes access to at least one resource. The resource can be any service, application, file, or other information associated with the task device that can be made available for use by or interaction with another task device, such as the camera 102a or camera phone 102c, via the network 116 to perform a particular task. For example, FIG. 1 shows that the task device 102b can provide resources including services 104 (e.g., web services and printer services), software applications 108, and files 112 (such as image files). Other task devices, such as the camera 102a or camera phone 102c, can publish requests for information or services related to these resources and/or the tasks they are capable of performing using the pubsub service 120 via the network 116.

The workflow server 130 is coupled to a workflow database 132 that stores a plurality of configured workflows. In one embodiment, the workflow server 130 is configured to interpret a workflow's policies and rules to determine which tasks and in what order the tasks should be performed. The workflow server 130 is also configured to allocate task requests to various task devices 102 using the pubsub protocol and to monitor the status of each of the tasks and task devices 102.

As stated above, the pubsub protocol used is preferably a presence protocol. Accordingly, in this embodiment, the pubsub server 118 and service 120 can be a presence server 118 and service 120 and the various task devices 102 and workflow server 130 can be configured to communicate using the presence protocol. Note that other pubsub protocols can be utilized and that the present invention is not limited to the presence protocol.

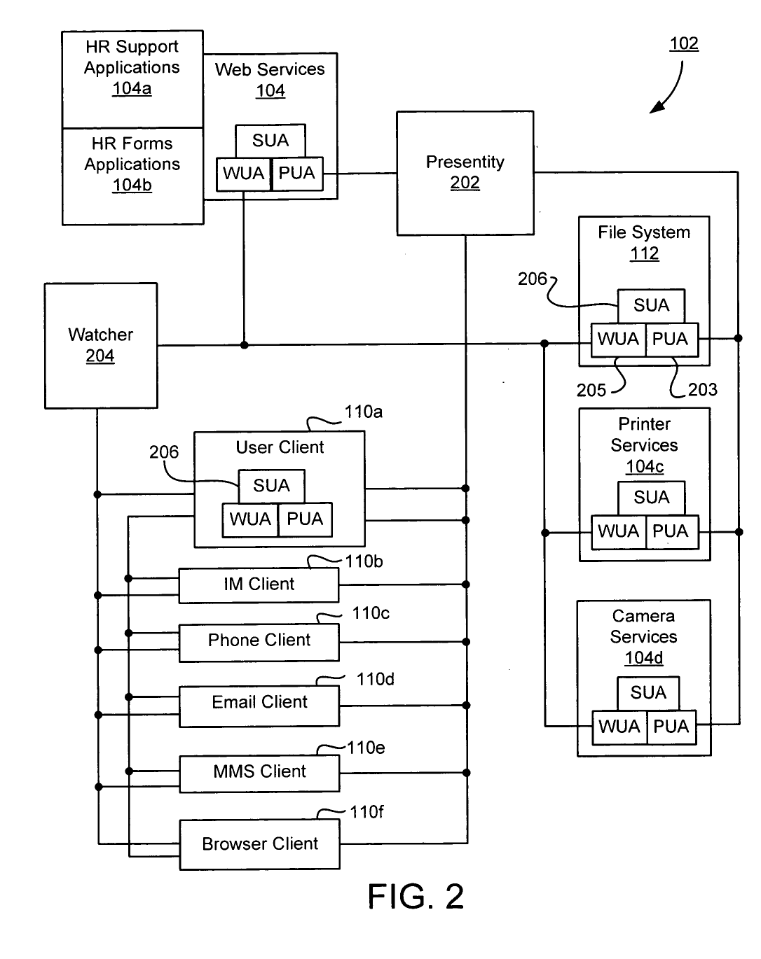

FIG. 2 is a block diagram illustrating the various components that can make up the task network device 102 that is configured to use a presence protocol. The arrangement shown in FIG. 2 represents a network device that is capable of receiving and responding to a request to perform a task in the workflow and publishing a request to perform a task in the workflow. Nevertheless, persons skilled in the art will understand that a task device that is capable of receiving and responding to a task request need not include the components necessary to make a task request, and vice versa.

According to FIG. 2, the task device 102b includes a presentity component 202, a watcher component 204 and various user agents including presentity user agents (PUA) 203, watcher user agents (WUA) 205 and service user agents (SUA) 206. The presentity component 204 can be configured to send information to the presence server 118 via the presence protocol using a publish command. The information can include a request to complete a task and/or a response to a request as well as status and contact information. In one embodiment, the information can also include a task descriptor for each task the task device 102 is capable of performing so that the task device 102 can advertise to the other task devices 102 its the task capabilities. The PUA 203 provides a suitable interface between the user and the presentity component 204.

The watcher component 204 can be configured to receive information from the presence server 118 via a notification. The received information can include a task request to complete a task and/or a response to a task request, task descriptors, as well as status and contact information of other presence entities. The WUA 205 provides a suitable interface between the user and the watcher component 204.

According to an exemplary embodiment, the task device 102b can include a service user agent (SUA) 206. The SUA component 206 is coupled to the resource 104, 108, 112 and to the presentity 202 and watcher 204 components. Like the PUA 203 and WUA 205 components described above, the SUA 206 can interact with the presentity 202 and watcher 204 components on behalf of a principal, typically via the PUA and WUA respectively. Generally, the SUA 206 will interact with the resource 104, 108, 112 as its principal, although the SUA 206 can also interact with an owner of the resource as well as other principals.

The SUA component 206 can be configured to facilitate a sending of the task descriptor(s) by the presentity component 202 to advertise the task capability to other presence entities coupled to the network 116. The SUA component 206 can provide an appropriate interface for an owner of a task to publish the task descriptor using the presence protocol. To provide an interface for the owner of the task, the SUA 206 can be coupled to a user communication client 110a or any number of associated communication clients, such as an IM communication client 110b, a phone client 110c, an email client 110d, a Multimedia Messaging Service (MMS) client 110d, and a browser client 110f (collectively, communication clients 110) as shown in FIG. 2.

The SUA 206 can also be configured to facilitate a sending of a request by the presentity component 202. The request can be automatically generated by the SUA 206 in response to some other action occurring in relation to a resource, e.g., an action by a related program running on the task device 102. Alternatively, an interface can be presented to a user/principal of the task device 102 to gather information needed to form the request. The SUA 206 can then forward the request to the presentity component 202 for publishing (perhaps with the assistance of an appropriate PUA 203), performing any translations of the request as needed.

The SUA 206 can be further configured to facilitate a processing of the task request received by the watcher component 204. The SUA 206 can be configured to forward the task request to the appropriate resource 104, 108, 112 for processing or can interpret and/or pre-process the request prior to its being forwarded to the resource. The SUA 206 can facilitate the processing of the task request without any user intervention or, if appropriate, can provide a suitable interface for gathering information, such as authorization, from the user.

In addition, the SUA 206 can be further configured to facilitate a sending of the response to the task request by the presentity component 202. The response can be a result of processing the task request issued by the workflow manager 300, e.g., in conjunction with a centralized workflow process, or a combination of a result of processing the task request and a subsequent task request for another of the task devices 102, e.g., in conjunction with the distributed (or peer-to-peer) workflow process model.

The SUA component 206 can interact directly with the resource(s) 104, 108, 112 responsible for completing the task to determine and publish the response, or can provide an appropriate interface for the user to publish the response using the presence protocol. For example, the SUA 206 can present an appropriate dialog box (not shown) to the user so that the user can provide the necessary information to form the response to the request. The SUA 206 can then forward the response to the presentity component 202 for publishing (perhaps with the assistance of an appropriate PUA 203), performing any translations of the response as needed.

In facilitating the exchange of information between the presentity 202 and watcher 204 components, the resource 104, 108, 112, and the communication clients 110, the SUA 206 may act in conjunction with appropriate PUAs 203 and/or WUAs 205 or may bypass the operation of these agents. Moreover, it will be understood that the SUA 206 for a particular resource can be combined with the PUA 203 and/or WUA 205 associated with that resource, or can be configured to act as a user agent for all resources associated with a particular device and/or owner. As with PUAs 203 and WUAs 205, the SUA 206 can be implemented such that its functionality exists within the presence service, external to the presence service, or a combination of both internal and external to the presence service.

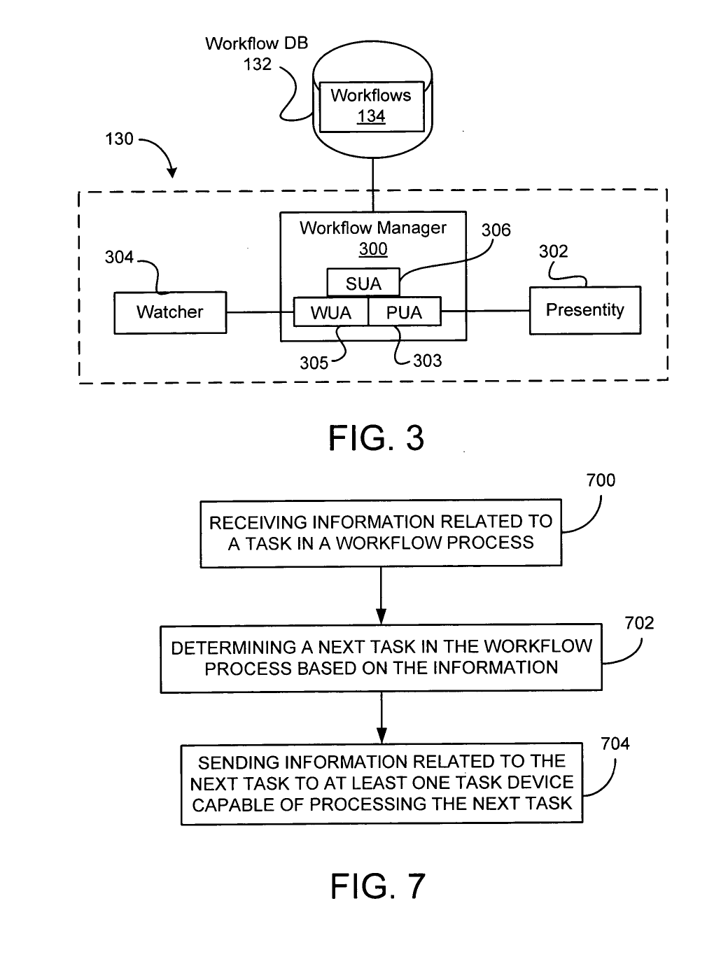

FIG. 3 is a block diagram illustrating the workflow server 130 according to one embodiment of the present invention. The workflow server 130 includes a workflow manager 300 that is coupled to the workflow database 132, which stores a plurality of configured workflows 134. The workflow server 130 includes a presentity 302 and PUA 303 for sending presence information to the presence service 120, a watcher 304 and WUA 305 for receiving presence information from the presence service 120, and an SUA 306 for making and responding to requests.

As stated above, the workflow manager 300 interprets the rules and policies of a workflow 134 and determines which tasks should be performed and in what order. To that end, the workflow manager 300 uses the presence protocol to publish requests, using its SUA 306 and presentity 302, to appropriate task devices 102 via the presence service 120 and receives responses, through its watcher 304, from the task devices 102 replying to the requests via the presence service 120.

While only one workflow manager 300 is shown in FIG. 3, a plurality of workflow managers can be implemented to provide load balancing and to improve performance. Each workflow manager 300 has access to the configured workflows 134 and therefore any of the workflow managers 300 can determine a next task that should be performed in a particular workflow based on the presence information received from the presence service 120. In addition, while the workflow database 132 is shown coupled to the workflow server 130, it can also reside with the presence server 118 or be distributed among the task devices 102. In this manner, the configured workflows 134 can be accessed by the workflow manager 300 as well as authorized task devices 102.

Referring again to FIG. 1, the presence server 118 can include the proxy service 124. The proxy service 124 can be configured to send presence information to entities through a firewall 114 associated with an entity. According to another exemplary embodiment, the presence server 118 can also include the account service 122. The account service 122 can be configured to authenticate an identity of each of the task devices 102 and to authorize a receiving by each of the task devices 102 of a request or a response prior to sending the request or response to the respective device.

Rosters and/or privacy lists may be used by the account service 122 to authorize and authenticate access to a particular resource or to prevent providers from advertising certain resources to subscribers. In this sense, the rosters and/or privacy lists can operate as access control lists (ACLs) for authenticating and authorizing resource usage among presence entities. The roster and/or privacy list data can be stored in a database, such as the account and authorization information database 128 coupled to the account service 122. Multiple rosters and/or privacy lists may be maintained in the database 128 and used by the account service 122. No new extension to the account service protocol for roster management is required to maintain the rosters or lists, however, the roster data can instead be included in tuple information and carried by the presence or other pubsub protocol.

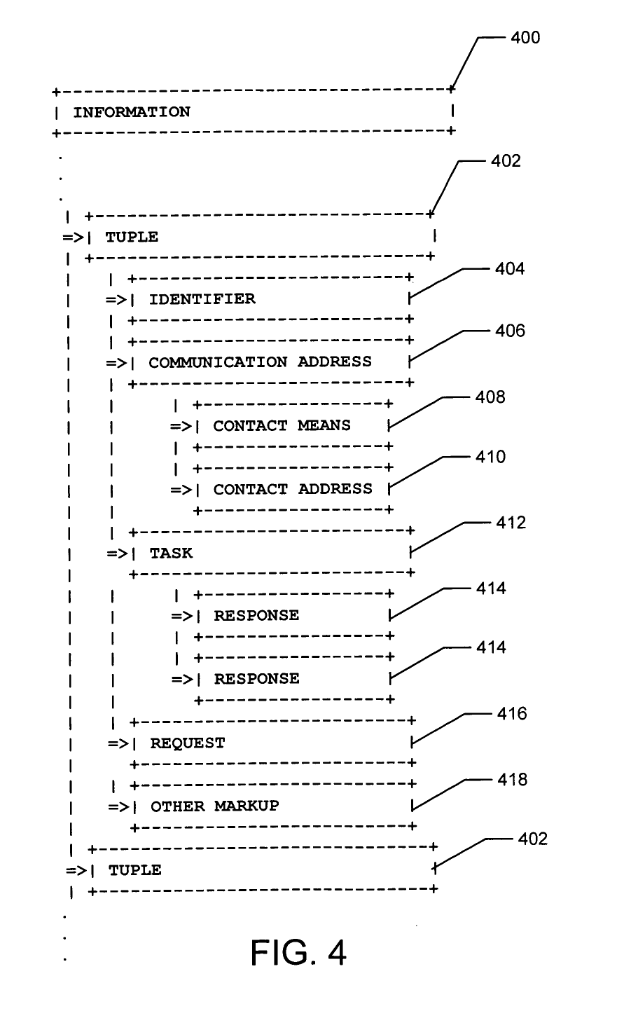

Referring now to FIG. 4, a data structure is illustrated for use with a pubsub protocol, such as a presence protocol, according to one embodiment of the present invention. For convenience, the data structure shown in FIG. 4 includes data objects and elements for storing the information of both a responding entity and a requesting entity (e.g., the task devices 102 and the workflow manager/task devices 300, 102 in the distributed and centralized workflow models, respectively). Nevertheless, persons skilled in the art will understand that a data structure for storing the information associated with a responding entity need not include the objects and elements necessary to store the information of a requesting entity, and vice versa.

The data structure shown in FIG. 4 may be contained in any suitable computer readable medium, including any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium, such as a removable storage device. More specific examples (a non-exhaustive list) of the computer readable medium can include the following: an electrical connection having one or more wires, a portable computer diskette, a random access memory (RAM), a read only memory (ROM), an erasable programmable read only memory (EPROM or Flash memory), an optical fiber, and a portable compact disc read only memory (CDROM).

The information 400 can be stored in a database coupled to the pubsub/presence server 118 shown in FIG. 1, such as the information database 126. Although a single database 126 is shown in FIG. 1, persons skilled in the art will understand that the information can be distributed throughout the network 116 across multiple databases and/or stored, at least in part, in memory associated with the task devices 102 shown in FIG. 1.

The tuple 402 shown in FIG. 4 includes standard data objects for storing identification 404 and communication address 406 information, and if the tuple 402 is a presence tuple, could include other data objects, e.g., for status, described in RFC 2778 and RFC 2779. For example, the tuple 402 can also include data objects for storing a contact means 408 and contact address 410, as well as a data object for storing other markup 418, thus maintaining the extensibility of the tuple 402 in accordance with presence standards. The tuple 402 can include any number of data objects to support the processing of workflow tasks when used in conjunction with a general pubsub protocol. When the tuple 402 maintains the standard form for presence protocols, such as that described in RFC 2778 and RFC 2779, the information 400 included in the tuple 402 can be carried across the network 116 using standard presence protocol commands. In either arrangement, it is not necessary for the pubsub/presence server 118 to understand the content of the tuple 402 in order to route the information contained therein to the various pubsub entities coupled to the network 116.

From the perspective of a responding entity, the tuple 402 can include a task data object 412, including an element (not expressly shown) for storing the task descriptor of a task associated with a workflow process. The task data object 412 can include a minimal amount information regarding the task and/or the workflow (as can be the case with a “dumb” task device 102 suitable for use in a centralized workflow process), or can include detailed information regarding the task and/or workflow to be performed and the relationship(s) between the task and workflow (as can be the case with a more sophisticated task device 102 suitable for using in a distributed workflow model).

From the perspective of a requesting entity, the tuple 402 can include a request data object 416. The request data object 416 can include an element for storing a request related to a task in the current workflow process or a task in a completely different workflow process published by a requesting entity. The requesting entity can be, for example, the presentity component 202 of the task device 102 (FIG. 2) or the presentity component 302 of the workflow server 130 (FIG. 3).

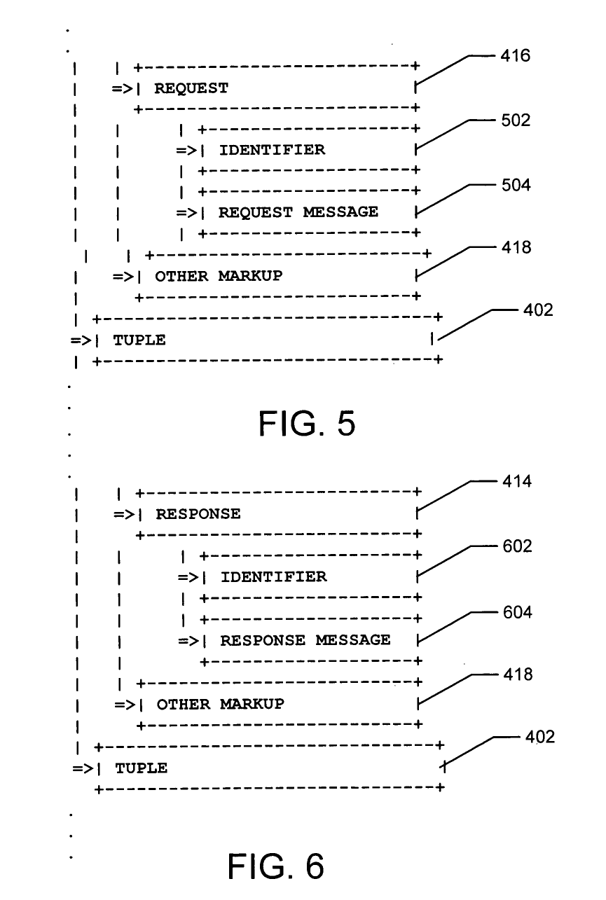

FIG. 5 shows an expanded view of the request data object 416 according to an embodiment of the present invention. As shown in the figure, the expanded view of the request data object 416 can include an element for storing an identifier element 502 for storing a task descriptor of a task associated with a responding entity capable of performing the task. The descriptor element 502 can include information to describe or identify only the task, or can include information to describe or identify both the responding entity and its associated task(s), such as a Uniform Resource Identifier (URI). The request data object 416 can also include a request message 504 related to the task.

The request message 504 can include information related to a task to be completed, for example, if the request is made by the workflow manager 300 and sent to the task device 102. In addition, or alternatively, the request message 504 can include information related to a task that has been completed. For example, in the distributed or peer-to-peer workflow model, a task device 102 that has completed its task and has determined which task device should perform the next task in the workflow can send a request to the next task device, and the request message 504 can include the result of the completed task.

Referring once again to the data structure of FIG. 4 from the perspective of a responding entity, the tuple 402 also includes a response data object 414 including an element for storing a response from the responding entity replying to the request message. It should be noted that FIG. 4 depicts two response data objects 414 linked to the task data object 412 in the tuple 402. Such an arrangement allows for the efficient storage and management of the information needed to respond to multiple task requests (from, e.g., multiple workflow managers 300 or related to separate workflows managed by the same workflow manager 300) that are related to a common task. Nevertheless, the arrangement shown in FIG. 4 is merely exemplary, and other arrangements for storing and managing the task, request, and response information are within the scope of the techniques describe here.

FIG. 6 shows an expanded view of the response data object 414 according to an exemplary embodiment. As shown in the figure, the expanded view of the response data object 414 can include an element for storing a response message 604 replying to the task request message stored in element 504. The response data object 414 can also include an identifier element 602 (similar to the identifier element 506 shown in FIG. 5) for storing an identifier, such as a URI, of an entity that is interested in the response, e.g., the workflow manager 300 or other task device 102. The pubsub/presence server 118 can use the identifier stored in the element 602 to route the response message stored in element 604 of the tuple 402 to the interested entity, if appropriate. It can be useful for the server 118 to use this identifier under circumstances when both the responding entity's information is being broadcast to all entities coupled to the network 116 (i.e., when a directed publish/notify command is not used) and the interested entity has not subscribed to at least the information of the responding entity that includes the response message, or when there is a need to notify other subscribed watchers of the response.

FIG. 7 is a flowchart illustrating a method for processing a workflow according to one embodiment of the present invention. The method can be carried out using the arrangement described in conjunction with FIGS. 1-3 and the data structure described in conjunction with FIGS. 4-6 above, portions of which are referenced in the description that follows. In particular, the method can be carried out using the pubsub/presence server 118. It will be understood that other arrangements and/or data structures can be used to carry out the described method without departing from the scope of the described techniques. Descriptions of certain terms, the meanings of which are described in detail above in conjunction with FIGS. 1-6, are not repeated here.

Moreover, the executable instructions of a computer program illustrated in FIG. 7 can be embodied in any computer readable medium for use by or in connection with an instruction execution system, apparatus, or device, such as a computer based system, processor containing system, or other system that can fetch the instructions from the instruction execution system, apparatus, or device and execute the instructions.

The method begins when a pubsub protocol, such as the presence protocol, is used for receiving information related to a task in a workflow (step 700). Based on the information related to the task, a next task in the workflow is determined (step 702). Once the next task is determined, the pubsub protocol is used to send information related to the next task to at least one task device capable of processing the next task (step 704). This process can be implemented in a centralized workflow management model or in a decentralized workflow model or a combination of both. The centralized and decentralized models will be described below.

Referring to FIGS. 1-7, in a centralized management model, the workflow manager 300 handles the workflow. In this embodiment, the workflow server 130 can receive the information related to the task via the pubsub server 118, such as the presence server (step 700). The workflow server 130 preferably receives the information through its watcher 304. The information related to the task preferably identifies the workflow and the task, and can include a result of the task that was completed by a responding task device 102. The information related to the task can be included in the response message 604 in the response data object 414 illustrated in FIG. 4 and FIG. 6.

The workflow manager 300 uses the information to retrieve the workflow 134 from the workflow database 132 and determines the next task based on the result and the rules and polices of the workflow 134 (step 702). The workflow manager 300 then prepares the information related to the next task, which can include a request to complete the next task, and uses the presentity 302 to send the information related to the next task to at least one task device 102 that is capable of processing the next task (step 720) via the pubsub server 118. The information related to the next task can be included in the request message 504 in the request data object 416, illustrated in FIG. 4 and FIG. 5.

In one embodiment, the workflow manager 300 can subscribe to receive presence information associated with a plurality of task devices 102 from a presence service 120. The presence information can include the status of the task device 102, i.e., whether it is available, and other information, such as the task(s) it is capable of performing, price, average response time, etc. The workflow manager 300 can then select to which task device(s) 102 to send the request based on criteria, i.e., price, workload balancing, and availability. In another embodiment, the workflow manager 300 can broadcast a request to complete the next task to all task devices 102.

In another embodiment, the workflow manager 300 can receive a request from a requesting user to initiate a workflow. The request can be received through the presence server 118 or through other communication means, such as email. The workflow manager 300 retrieves the workflow 134, determines a first task in the workflow, and then uses the pubsub protocol to send a request to complete the first task to one or more task devices 102 capable of performing the first task. The workflow manager 300 then performs the process described in FIG. 7 until the workflow manager 300 receives the result of a last task in the workflow via the pubsub/presence server 118. At this point, the workflow manager 300 can use the pubsub protocol to send a final outcome of the workflow to the requesting or target user if the requesting user is subscribed to the pubsub service 120. Otherwise, the workflow manager 300 can use an appropriate communication protocol to send the final outcome to the requesting or target user.

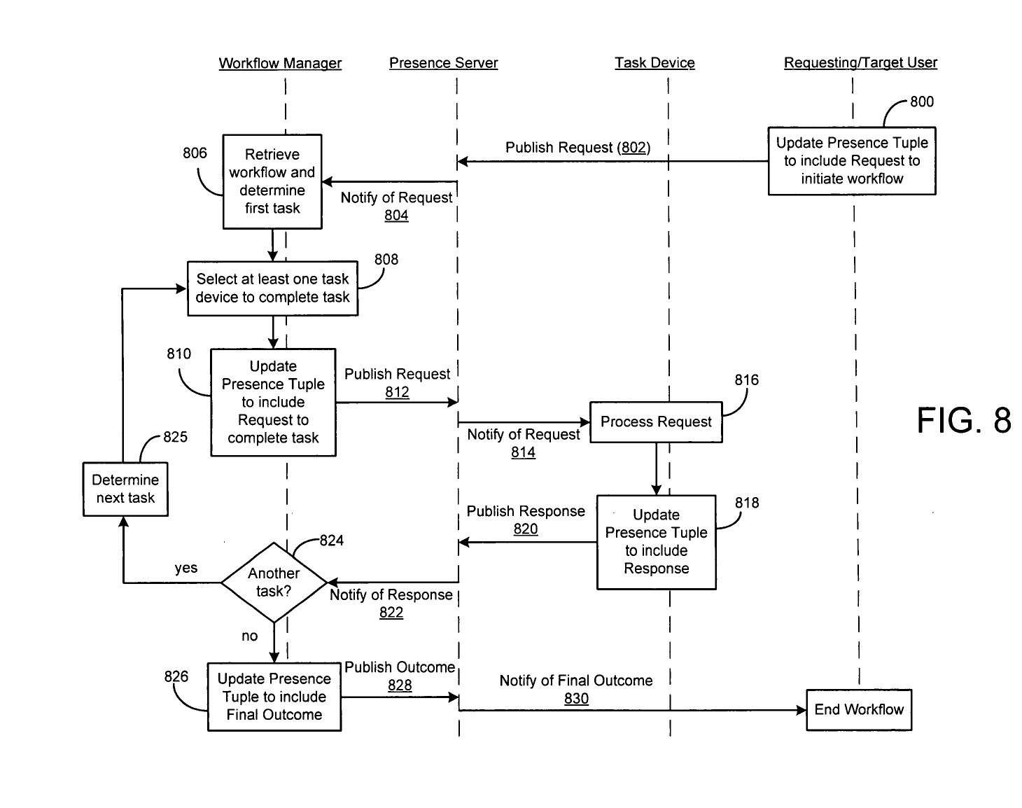

FIG. 8 is a sequence diagram illustrating the method for processing the workflow using a centralized workflow manager 300 according to an embodiment of the present invention. In this example, a presence protocol is used to communicate between presence entities and a presence server 118. A requesting user is subscribed to the presence service 118 and uses its PUA to update its presence tuple to include a request to initiate a workflow (step 800). The requesting user's presentity 202 (FIG. 2) then publishes the updated presence tuple that includes the request to the presence server 118 (step 802). For example, the requesting user can be a worker who would like to make a request for vacation time, and initiates a vacation workflow process.

The presence server 118 receives the updated presence tuple that includes the request from the presentity 202 and sends it to the workflow server 130 via a notify portion of a directed publish/notify command (step 804). Alternatively, the request can be sent via a notify command in response to a subscription by the workflow manager entity 304 (FIG. 3) to the presence information of the requesting user entity. Once received by the workflow server entity, i.e., the watcher 304, the workflow manager 300 retrieves the workflow 134 from the workflow database 132 and determines a first task (step 806). In one embodiment, the workflow database 132 is coupled to the workflow server 130 and the workflow 134 is retrieved directly. In another embodiment, the workflow database 132 is coupled to the presence server 120 and the workflow manager 300 can use the presence protocol to retrieve the workflow 134 and rules via the presence server 120. In this arrangement, the presence server 120 handles the workflow 134, authentication, configuration and monitoring functions, thereby creating a simple and flexible workflow management system.

The workflow manager 300 then selects at least one task device 102 that is capable of completing the task (step 808), updates its presence tuple to include a request to complete the task (step 810). In one embodiment, the request can include an identifier for the workflow 134 and an identifier for the task. The workflow server 130 then uses its presentity 302 to publish the updated tuple that includes the request (step 812). Alternately, the workflow manager 300 may simply identify the next task and publish a request to have the task performed. A subscribed task device 102 would receive a notification, complete the task, and publish a response.

If more than one task device 102 is subscribed, any number of methods may be used to determine which task device 102 can handle the request. A simple example is that the first task device 102 to respond is used and later responses are discarded. Or, the request may include a priority indicator or other information which determines which task device 102 will perform the task.

Referring again to the vacation request example, the workflow manager 300 retrieves the vacation workflow 134 from the database 132, and determines that the first step in the process is to use a calendaring service (CS) 104 to verify that the requested vacation dates do not affect projects in which the requesting user is involved. The workflow manager 300 uses its watcher 304 to determine the availability and status of at least one task device 102 that offers a CS 104 and selects the first available task device 102. The workflow manager 300 then uses its SUA 306 to update its presence tuple to include the request to verify the vacation dates and uses its presentity 302 to publish the request to the presence server 118.

The presence server 118 sends the updated tuple to the selected task device 102 in a notification (step 814). The selected task device 102 can be subscribed to the presence information of the workflow manager 300 and receive notifications from the presence server 118 pursuant to its subscription. The selected task device 102 receives the notification through its watcher 204, uses the SUA 206 to route the request to the appropriate service 104, and processes the request (step 816). Thereafter, the SUA 206 updates the task device's presence tuple to include a response to the request (step 818). In one embodiment, the response includes the identifiers for the workflow 134 and the task. The task device 102 then uses its presentity 202 to publish the response to the presence server 118 (step 820), which in turn sends the response back to the workflow manager 300 (step 822).

Referring again to the vacation request example, the request to verify the vacation dates is sent to the task device 102 from the presence server 118. The task device 102 uses its watcher 204 to receive the request, and uses its SUA 206 to route the request to the CS 104. The CS 104 verifies that the requested vacation dates do not adversely impact the projects in which the requesting user is involved, and returns a response that the requested vacation dates are verified. The SUA 206 updates the presence tuple and the presentity 202 sends the response back to the workflow manager 300 via the presence server 118.

When the workflow manager 300 receives the response from the presence server 118, the workflow manager 300 determines whether the workflow requires another task (step 824) based on the response. In one embodiment, the workflow manager 300 uses the workflow identifier to retrieve the workflow 134 from the database 132 and then uses the task identifier to determine which task in the workflow 134 was completed. By including the identifiers for the workflow 134 and task in the response, any one of a plurality of workflow managers 300 can handle the response. Accordingly, the workflow server 130 can distribute workload between the plurality of managers 300 and improve performance and reliability.

In some instances, the next task is determined by a rule or policy related to the response of the previous task. Accordingly, in those cases, the workflow manager 300 applies the rule to the response to determine the next task, if one exists. For example, referring again to the vacation request example, the workflow manager 300 retrieves the vacation workflow 134 from the database 132 and determines that more tasks follow the first task. The workflow manager 300 then determines what the next task is based on the response and the rule governing the selection of the next task. The rule can be: if the response to the first task is negative, i.e., the requested vacation days have an adverse impact on the projects, the next task is to inform the requesting user that vacation cannot be granted; otherwise, the next task is to get approval from the requesting user's manager using an approval service (AS).

If the workflow 134 includes another task (step 824), then the next task is determined (step 825) and steps 808 through 822 are repeated. If each of the tasks in the workflow 134 is completed (step 825), the workflow manager 300 generates a final outcome (step 826). The final outcome is then returned to the requesting or target user via the presence server 118 (steps 828 and 830).

Referring again to the vacation request example, the response to the first task is positive and therefore the workflow manager 300 determines that the next task is to get the approval of the requesting user's manager. The workflow manager 300 selects at least one task device 102 that offers the approval service (AS) 104, updates its presence tuple to include a request for approval, and sends the request to the task device 102 via the presence server 118. The AS 104 in the task device 102 contacts that manager, who gives her approval, and the task device 102 updates its presence tuple to include a response approving the vacation days. The updated presence tuple with the response is sent to the workflow manager 300 via the presence server 118. The workflow manager 300 determines that the vacation workflow is completed, updates its presence tuple to include a response granting the vacation, and sends the response to the requesting user via the presence server 118.

Turning now to the decentralized or distributed (peer-to-peer) model, the workflow is passed from task device 102 to task device 102, instead of between the workflow manager and task devices 102. Referring again to FIG. 7, in this embodiment, a task device 102 can use its watcher 204 to receive the information related to the task via the pubsub server 118, such as the presence server (step 700). The information related to the task preferably identifies the workflow 134 and a request to complete a task in the workflow 134. The information also preferably includes any data needed to complete the task. The information related to the task can be included in the request message 504 in the request data object 416, illustrated in FIG. 4 and FIG. 5.

The task device 102 uses its watcher 204 to route the request to a service 104 that can perform the task and the request is processed to produce a result. The task device 102 then determines the next task in the workflow 134 based on the result and the rules and policies of the workflow 134 (step 702). In one embodiment, the workflow database 132 can be coupled to the presence server 118, and the task device 102 can retrieve the relevant rules using the workflow identifier and a task identifier. In another embodiment, the service 104 can be hard coded with the rules for the particular task. In another embodiment, the task device 102 can be configured with the rules for only the workflow task(s) for which it is capable of completing via notifications from the pubsub server 118.

Once the task device 102 determines the next task, it then prepares the information related to the next task, which can include a request to complete the next task and data needed to complete the next task, and uses the presentity 302 to send the information related to the next task to at least one task device 102 that is capable of processing the next task (step 704) via the pubsub server 118. The information related to the next task can be included in the request message 504 in the request data object 416, illustrated in FIG. 4 and FIG. 5.

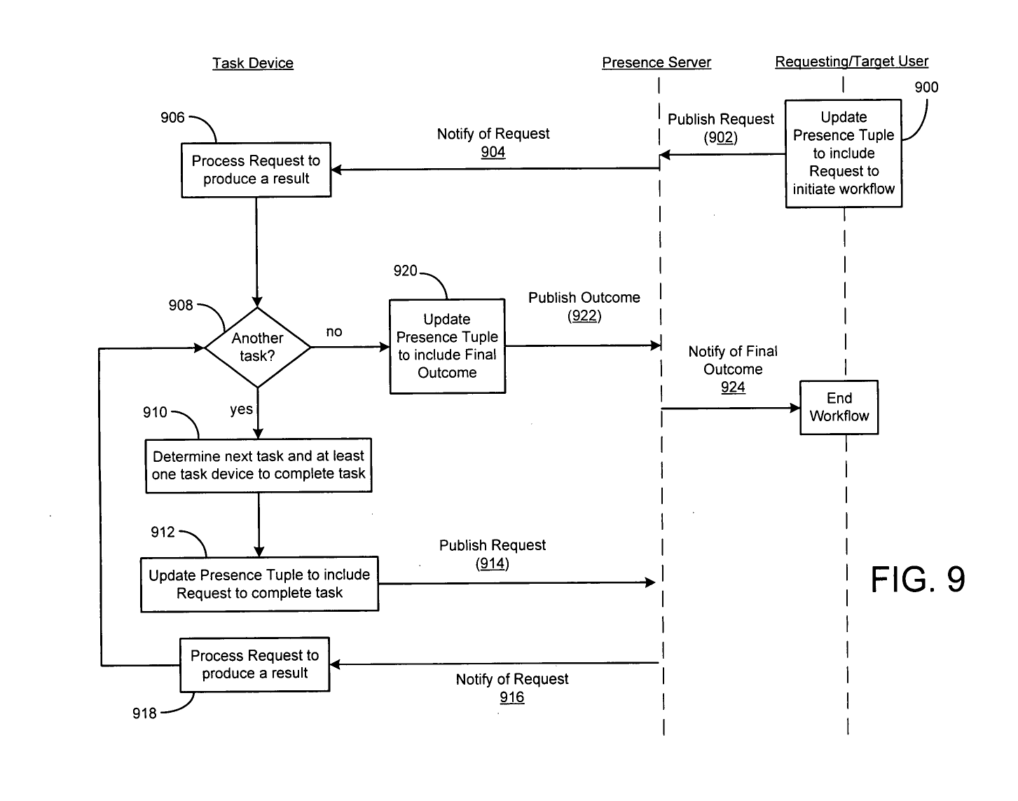

FIG. 9 is a sequence diagram illustrating the method for processing the workflow using a distributed network of task devices 102 according to an embodiment of the present invention. In this example, a presence protocol is used to communicate between presence entities and a presence server 118. A requesting user is subscribed to the presence service 118 and uses its PUA to update its presence tuple to include a request to initiate a workflow (step 900). The requesting user's presentity 202 (FIG. 2) then publishes the updated presence tuple that includes the request to the presence server 118 (step 902).

The presence server 118 receives the updated presence tuple that includes the request from the requesting user entity 202 and sends it to a task device 102 that is capable of performing the first task in the workflow 134 (step 904). The request is sent via a notify portion of a directed publish/notify command or via a notify command in response to a subscription by the task device 102 entity 204 to the presence information of the requesting user entity.

The task device 102 receives the notification through its watcher 204, uses the SUA 206 to route the request to the appropriate service 104, and processes the request to produce a result (step 906). The task device 102 then determines whether the workflow 134 requires another task (step 908). If another task exists, the task device 102 determines the next task based on the result and one or more rules governing the selection of the next task and identifies at least one task device 102 that is capable of completing the next task (step 910).

Then, the SUA 206 updates the task device's presence tuple to include a request to complete the next task (step 912). In one embodiment, the request includes identifiers for the workflow 134 and the next task. The task device 102 then uses its presentity 202 to publish the request to the presence server 118 (step 914), which in turn sends the request to the selected task device 102 capable of performing the next task (step 916). The next task device 102 processes the request to complete the next task to produce a result (step 918) and steps 908 through 918 are repeated until each of the tasks in the workflow 134 is completed.

If each of the tasks in the workflow 134 is completed (step 908), the task device 102 that performed the last task generates a final outcome and updates its presence tuple to include the final outcome (step 920). The final outcome is then returned to the requesting user or sent to a target user via the presence server 118 (steps 922 and 924) or other communications means.

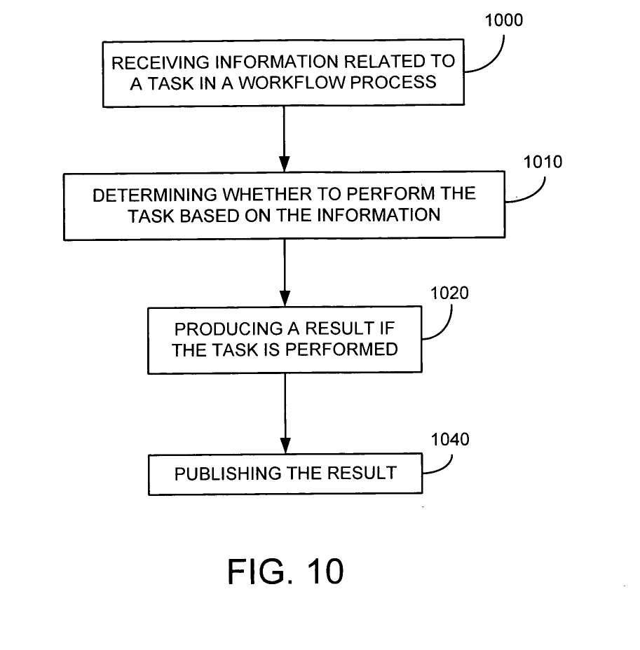

FIG. 10 illustrates another method of processing a workflow using a distributed network of task devices 102 according to another embodiment of the present invention. In this embodiment, each task device 102 uses its watcher 204 to receive information related to a task from the presence server 118 (step 1000). The information related to the task can include an identifier for the workflow and/or task, as well as data related to the task. In a preferred embodiment, the task device 102 can be configured to take an action (or take no action) based on the information related to the task. Thus, the watcher 204 watches for particular workflow identifiers and/or particular data, e.g., responses, to determine whether to perform the task (step 1010).

For example, a task device 102 can be configured to perform a task only if it identifies a certain workflow identifier and a particular response. If such matching conditions exist, the task device 102 performs the task and produces a result (step 1020). The task device 102 then updates its presence tuple to include the workflow identifier and the result. The updated presence tuple including the result is then published to the presence server 118 (step 1040). Here, the updated presence tuple will be sent to other task devices 102 pursuant to their subscriptions to the presence information of the responding task device 102. The next task will be performed by a task device 102 that is capable of performing the next task if the workflow identifier and/or result match its configuration.

Although a pure centralized and a pure distributed architecture have been described above with regard to FIG. 8 and FIG. 9, a particular system can be a mixture of the two. For example, certain tasks in the workflow 134 can be handled by the workflow manager 300 while other tasks in the same workflow 134 can be passed directly between task devices 102. In another embodiment, the workflow manager 300 can be used to provide rules and policies, tasks and other information related to a workflow.

In addition, the workflow management system of the present invention can be mixed with requests and responses that do not flow through the pubsub server 118. For example, the workflow can be initiated by a requesting user at a web page causing the web server to call the workflow manager 300 directly to start a workflow process. Task devices 102 can make direct calls to other task devices 102 through protocols other than the pubsub protocol and the workflow manager 300 can call services 104 through means other than the pubsub protocol.

Methods and a system for processing a workflow using a pubsub protocol have been described. In the preferred embodiment communication among the task devices 102 and between the workflow manager 300 and the task devices 102 is implemented using a pubsub protocol, and preferably a presence protocol. The presence protocol is used not only to monitor and manage presence information, but also to publish the actual task requests and to receive the responses. As a result, the pubsub service, and preferably the presence service, manages authentication, authorization, monitoring and management of all workflow tasks, as well as logging, service registration, and load balancing among the task devices 102. In one embodiment, the presence service 120 may share some of these responsibilities with the workflow manager 300.

In one embodiment, the workflow server 130 is required only to interpret the rules associated with the workflows to determine the next step, and to work with the presence server 118 to route requests. Thus workflow servers 130 are more simple because the presence services 118 already provide many of the services workflow managers 300 traditionally provide. This reduces duplicate and typically non-interoperable services on a network making management, maintenance, and interoperation easier.

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method for processing a workflow, the method comprising:
using a publish-subscribe protocol to receive from a server information related to a task in a workflow process, wherein the workflow process comprises a plurality of tasks to produce a final outcome;
determining a next task in the workflow process based on the information; and
using the publish-subscribe protocol to send via the server information related to the next task to at least one task device capable of processing the next task.

2. The method of claim 1 wherein the information related to the task includes a result for the task, and wherein determining the next task comprises:
using the information related to the task to identify the workflow process;
retrieving and analyzing the workflow process to identify at least one possible next task; and
selecting the next task from the at least one possible next tasks based on the result for the task.

3. The method of claim 1 wherein the information related to the next task includes a request to complete the next task.

4. The method of claim 1 wherein the server is a presence server and the method further includes:
receiving from the presence server presence information associated with a task device capable of processing the next task; and
selecting the task device capable of processing the next task based on the associated presence information.

5. The method of claim 1 wherein the server is a publish-subscribe server.

6. The method of claim 1 comprising repeating the receiving, determining, and sending process until each task of the workflow is completed.

7. The method of claim 1 further comprising:
receiving a request from a requesting user to initiate the workflow process;
determining a first task in the workflow process;
selecting at least one task device capable of processing the first task; and
using the publish-subscribe protocol to send via the publish-subscribe server a request to the at least one task device capable of processing the first task.

8. The method of claim 7 further comprising:
using the publish-subscribe protocol to send via the publish-subscribe server the final outcome to the requesting user when the workflow process is completed.

9. The method of claim 1 wherein the information related to the task includes data needed to perform the task and the method further includes:
processing the task using the data to produce a result; and
providing at least one rule corresponding to the task, the at least one rule indicating the next task based on the result.

10. The method of claim 9 wherein providing the at least one rule includes receiving via the publish-subscribe server at least one message including the at least one rule.

11. The method of claim 9 wherein providing the at least one rule includes hard coding the at least one rule.

12. The method of claim 9 wherein determining the next task in the workflow process includes applying the at least one rule to the result.

13. The method of claim 9 wherein the information related to the next task includes the result.

14. A method for processing a workflow comprising:
using a publish-subscribe protocol to receive from a server information related to a task in a workflow process including a plurality of tasks;
determining whether to perform the task based on the information;
producing a result if the task is performed; and
using the publish-subscribe protocol to publish the result via the server.

15. The method of claim 14 wherein the publish-subscribe protocol is a presence protocol and the method comprising:
subscribing to presence information related to a previous task in the workflow process.

16. The method of claim 15 wherein determining whether to perform the task includes using a watcher to monitor the presence information related to a previous task, and if the presence information includes certain matching data, performing the task.

17. A system for processing a workflow that comprises a plurality of tasks for producing a final outcome, the system comprising:
a server configured to receive, store, and distribute information using a publish-subscribe protocol; and
a plurality of task devices, wherein at least one task device is configured to perform a task in the workflow and is configured to exchange information with the server using the publish-subscribe protocol.

18. The system of claim 17 wherein the server is a publish-subscribe server.

19. The system of claim 17 further comprising:
a storage device for storing the workflow; and
a workflow manager configured to exchange information with the server using the publish-subscribe protocol and to manage the workflow by allocating task requests to appropriate task devices.

20. The system of claim 19 wherein the workflow manager is configured to receive from the server information related to a task in the workflow, to use the information to retrieve the workflow from the storage device, to determine a next task in the workflow based on the information and to send via the server information related to the next task to at least one of the task devices capable of performing the next task.

21. The system of claim 20 wherein the information related to the next task includes a request to complete the next task.

22. The system of claim 21 wherein the server is a presence server configured to receive, store, and distribute information using a presence protocol, the task device further including:
a task watcher component configured to receive via the presence server the request related to the task; and
a task presentity component configured to send the result to the presence server; and
wherein the workflow manager includes:
a workflow watcher component configured to receive from the presence server the information related to the task; and
a workflow presentity component configured to send the request to the presence server.

23. The system of claim 22 wherein the workflow watcher receives from the presence server presence information associated with a plurality of task devices capable of processing the next task and the workflow manager is configured to select the at least one task device for the next task based on the associated presence information.

24. The system of claim 17 wherein the task device is configured to receive from the server data needed to perform the task, to use the data to produce a result, to apply at least one rule to the task to determine a next task in the workflow, and to send via the server the result to at least one other task device capable of performing the next task.

25. The system of claim 17 wherein the task device is configured to receive from the server information related to the task, to determine whether to perform the task based on the information, to produce a result if the task is performed, and to publish the result via the server.

26. A computer readable medium containing a computer program for processing a workflow over a distributed network, the computer program comprising executable instructions for:
using a publish-subscribe protocol to receive from a server information related to a task in a workflow process, wherein the workflow process comprises a plurality of tasks to produce a final outcome;
determining a next task in the workflow process based on the information; and
using the publish-subscribe protocol to send via the server information related to the next task to at least one task device capable of processing the next task.

27. The computer readable medium of claim 26 wherein the server is a presence server and the computer program further includes executable instructions for:
receiving from the presence server presence information associated with a task device capable of processing the next task; and
selecting the task device capable of processing the next task based on the associated presence information.

28. The computer readable medium of claim 26 wherein the server is a publish-subscribe server.
